(19) United States
(12) Patent Application Publication
(10) Pub. No.: US 2025/0111667 A1
(43) Pub. Date: Apr. 3, 2025

(54) DARDA: Domain-Aware Real-Time Dynamic Adaptation of Edge-Assisted Neural Networks

(71) Applicants: Northeastern University, Boston, MA (US); Government of the United States as Represented by the Secretary of the Air Force, Wright-Patterson AFB, OH (US)

(72) Inventors: Shahriar Rifat, Westbrook, ME (US); Francesco Restuccia, Boston, MA (US); Jonathan Ashdown, Arlington, VA (US); Kurt Turck, Arlington, VA (US)

(21) Appl. No.: 18/824,858

(22) Filed: Sep. 4, 2024

Related U.S. Application Data
(60) Provisional application No. 63/580,492, filed on Sep. 5, 2023.

(51) Int. Cl. G06V 10/98; G06V 10/74; G06V 10/776; G06V 10/82; G06V 20/56

(52) U.S. Cl. CPC G06V 10/993; G06V 10/74; G06V 10/776; G06V 10/82; G06V 20/56

(57) ABSTRACT

Adapters for Deep Neural Networks (DNNs) are described for use in the presence of corruption/noise affecting inputs. These adapters can proactively learn latent representations of different corruption types, each associated with a sub-network state tailored to correctly classify inputs affected by that corruption. After deployment, they adapt the DNN to previously unseen corruptions in an unsupervised fashion by (i) estimating the latent representation of the ongoing corruption; (ii) selecting the sub-network whose associated corruption is the closest in the latent space to the ongoing corruption; and (iii) adapting the DNN state, so that its representation matches the ongoing corruption. Resource-efficient and swift adaptation to new distributions caused by different corruptions can be achieved without requiring a large variety of input data.

### RELATED APPLICATION

This application claims the benefit of U.S. Provisional Application No. 63/580,492, filed on Sep. 5, 2023. The entire teachings of the above application(s) are incorporated herein by reference.

### GOVERNMENT SUPPORT

This invention was made with government support under Grant Nos. 2201536, 2134973, 2134567, and 2120447 from the National Science Foundation, and Grant Number FA9550-23-1-0261 by the Air Force Office of Scientific Research. The government has certain rights in the invention.

### BACKGROUND

Test Time Adaptation (TTA) has emerged as a practical solution to mitigate performance degradation of Deep Neural Networks (DNNs) in the presence of corruption/noise affecting inputs. Existing approaches in TTA continuously adapt the DNN, leading to excessive resource consumption and performance degradation due to accumulation of error stemming from lack of supervision. Accordingly, new approaches are needed.

### SUMMARY

The invention relates to systems and methods for Domain-Aware Real-Time Dynamic Adaptation (DARDA), which can address such issues. In some embodiments, DARDA proactively learns latent representations of some corruption types, each one associated with a sub-network state tailored to classify correctly inputs affected by at least one of the corruption types. After deployment, DARDA adapts a DNN to previously unseen corruptions in an unsupervised fashion by (i) estimating a latent representation of an ongoing corruption; (ii) selecting a sub-network of the DNN whose associated corruption is the closest in the latent space to the ongoing corruption; and (iii) adaptinga DNN state, so that its representation matches the ongoing corruption. In this manner, DARDA can be more resource-efficient and can swiftly adapt to new distributions caused by different corruptions without requiring a large variety of input data. Experiments performed with two popular mobile edge devices—Raspberry Pi® and NVIDIA Jetson Nano—show that DARDA reduced energy consumption and average cache memory footprint respectively by 1.74× and 2.64× with respect to the state of the art, while increasing the performance by 10.4%, 5.7% and 4.4% on CIFAR-10, CIFAR-100 and TinyImagenet. As is known in the art, these are image datasets. CIFAR refers to the Canadian Institute For Advanced Research. As known in the art, CIFAR-10 and CIFAR-100 are labeled subsets of the 80 million tiny images dataset. CIFAR-10 and CIFAR-10 contains 10 and 100 classes, respectively. TinyImagenet contains 200 classes of downsized images.

Accordingly, in one example embodiment, the invention relates to systems, and corresponding methods, for adapting a deep neural network having a plurality of subnetworks, such as through an adapter comprising (a) a corruption information extractor to extract a representation of corruption from current data; (b) a corruption encoder to encode the representation of corruption affecting current data into a corruption signature; (c) a sub-network selector configured to select a sub-network from among the plurality of subnetworks of the deep neural network, each of the subnetworks being associated with a degree or type of corruption and having corresponding sub-network corruption signatures from the sub-network encoder, the selection being based on a distance of the current corruption signature from the sub-network corruption signatures; and (d) an update module configured to update the deep neural network based on an error output by the deep neural network using the sub-network selected.

In other embodiments, there may be at least one or a combination of any of the following aspects: (1) the corruption information extractor is configured to extract the representation of corruption from the current data based on a comparison of two downsampled versions of the current data; (2) the corruption encoder is configured to project the representation of corruption of the current data into a latent space to encode the current corruption signature; (3) the sub-network encoder is further configured to extract a representation of the sub-network state from each of the plurality of subnetworks; (4) the sub-network encoder is further configured to encode the representation of the current updated sub-network state into the corresponding sub-network signature; (5) the selected sub-network is updated based on the error output calculated from the distance between the current corruption signature and the sub-network signature; (6) the deep neural network is employed in an autonomous or semi-autonomous machine (e.g., a vehicle such as an automobile) to cause the machine to exhibit performance characteristics, and the adapter is coupled to a sensor arranged to obtain the current data from an environment at the machine, the environment known to have corruption effects associated therewith that cause the sensor to obtain the current data with corruption, optionally wherein the machine is a vehicle and the deep neural network is associated with processing images of a scene at the vehicle, the adapter configured to update the deep neural network at transitions of corruption effects, and optionally wherein the corruption effects include at least one of: fog, snow, rain and sunlight.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a diagram of a scene depicting use of Deep Neural Network (DNN) according to aspects of the present invention.

FIG. 1B is a schematic diagram providing an overview of an embodiment of Domain-Aware Real-Time Dynamic Adaptation (DARDA) framework and methodology.

FIG. 1C is a schematic showing components and information flows for an embodiment of a DARDA implementation.

FIGS. 2A and 2B are graphs that depict current issues of test-time adaptation.

FIG. 2A shows an increase in resource consumption with respect to inference-only adaptation.

FIG. 2B depicts adaption latency for Jetson Nano™ and Raspberry Pi® for different corruption types.

FIG. 3 provides is a schematic diagram that provides a depiction of an example embodiment of a Corruption Extractor according to aspects of the present invention.

FIGS. 4A, 4B, and 4C are graphs that show performance comparisons in different popular corruption benchmark datasets (unseen corruptions). FIG. 4A corresponds to CIFAR-10. FIG. 4B corresponds to CIFAR-100. FIG. 4C corresponds to Tiny Imagenet.

FIG. 5 is a graph that depicts performance across first five data batches for continuously incurred corruption on CIFAR-100.

FIGS. 6A and 6B are graphs that depict performance versus correlation coefficient and batch size.

FIGS. 7A and 7B are graphs that show energy consumption on common edge devices for a batch of 64 data samples. FIG. 7A corresponds to CIFAR-100. FIG. 7B corresponds to Tiny Imagenet.

FIGS. 8A and 8B are graphs that depict performance when 5 uncorrupted data batches are fed after every adaptation, for CIFAR-100 and 8=0.01. FIG. 8A depicts a given sequence (saturate, Gaussian blur, spatter, speckle). FIG. 8B depicts a different sequence (Gaussian blur, saturate, spatter, speckle).

FIGS. 9A and 9B are graphs that depict adaptation latency on common edge devices for a batch of 64 data samples. FIG. 9A corresponds to CIFAR-100. FIG. 9B corresponds to Tiny Imagenet.

FIG. 10 shows schematics that depict domain generalization (DG) approaches. (xₜ, yₜ) indicate the current test sample and its true label, while (xₚ, yₚ) indicate source sample and its true label. ŷₜ indicates the corresponding predictions by the current DNN. Note that DARDA is a Test Time Adaptation (TTA) approach.

FIG. 11 shows images depicting an example of label distribution and corruption shift.

FIG. 12 is picture of a power measurement setup according to an example embodiment.

FIGS. 13A, 13B, 13C, and 13D are scatter plots of t-distributed stochastic neighbor embedding (t-SNE) of different samples in latent space for CIFAR-10. Here, the green, orange, blue, and red colors indicate Gaussian blur, speckle noise, and saturate; respectively. FIG. 13A corresponds to a projection of corrupted data (low severity). FIG. 13B corresponds to a projection of extracted corruption (low severity). FIG. 13C corresponds to a projection of corrupted data (high severity). FIG. 13D corresponds to a projection of extracted corruption (high severity).

FIG. 14 shows pictures that depicts a performance (accuracy on CIFAR-10) comparison of a sub-network signature closest to an unknown corruption signatures in latent space. The leftmost column indicates the corresponding sub-network signatures. The unknown corruption domain and its closest sub-network signatures from latent space are: Spatter→JPEG Compression, Gaussian Blur→Glass Blur, Speckle Noise→Shot Noise, Saturate→Brightness.

### DETAILED DESCRIPTION

A description of example embodiments follows. The teachings of all patents, published applications and references cited herein are incorporated by reference in their entirety.

Traditional mobile edge computing scenarios assume that inputs of Deep Neural Networks (DNNs) are received uncorrupted. However, in many real-life scenarios, sudden and unexpected corruptions (e.g., snowy or foggy conditions) can cause a drastic change in data distribution, consequently causing performance loss [1, 15]. For example, a semantic segmentation DNN trained with data collected in normal weather conditions has been shown to exhibit a performance loss of more than 30% when tested in snowy conditions, while an image classification DNN can experience a similar decrease in the case of reduced lighting conditions.

Test-time Adaptation (TTA) tackles this issue by adapting the DNN with unlabeled test data in an online manner, thus handling distributional shifts in real time. Existing TTA methods encounter significant difficulty to perform optimally to continuously changing distributions when incoming samples are highly correlated in label space [17,19]. This assumption is true in many real-world scenarios. For example, an unmanned autonomous vehicle (UAV) monitoring an outdoor environment will likely encounter similar classes as video feeds are very likely to be highly correlated when considering limited time spans. Continuous adaptation of an edge-deployed DNN to such a challenging yet practical scenario causes many adaptation methods to fail. Moreover, existing methods lack awareness of when the domain shift happens, thus they continuously fine tune the DNN even if there is no shift in data distribution. However, in a real-life deployment scenario, certain data distribution might persist for a certain period of time (e.g., a bright sunny day). This imposes unnecessary burden on energy consumption and cache memory without yielding performance improvements.

To address the issues described above, a new framework has been developed and is disclosed hereinbelow, named Domain-Aware Real-Time Dynamic Adaptation (DARDA), aspects of which relate to an adapter for a DNN. While embodiments are described herein with respect to a DNN, it should be understood that alternative computational structures, currently or in the future available, may be employed without departing from teachings presented or contemplated herein. For simplicity, embodiments are described herein and illustrated in the accompanying drawings in reference to use of a DNN.

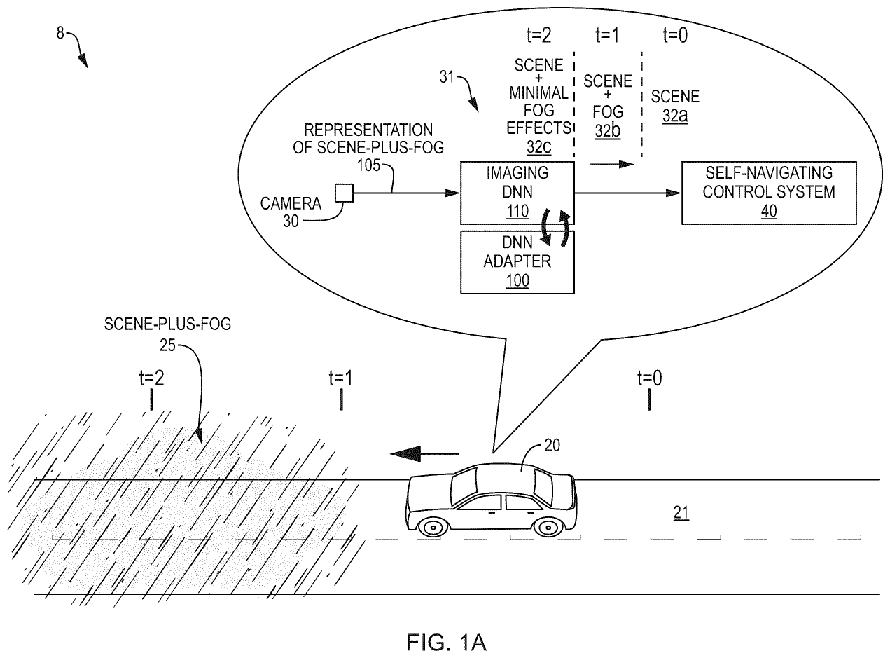

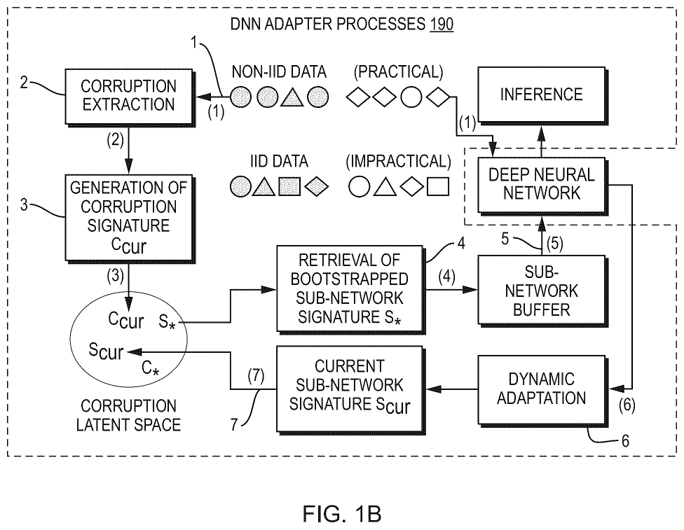

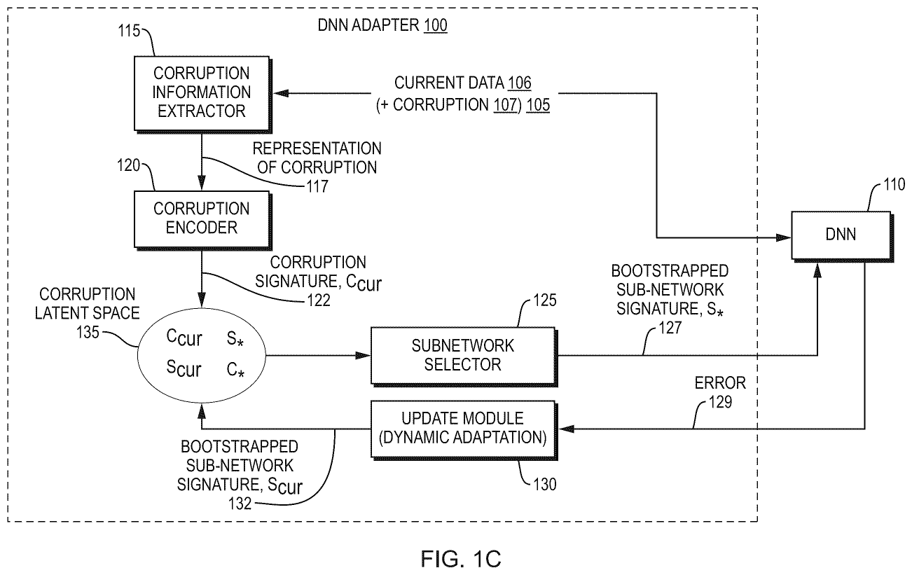

FIG. 1A is a diagram of a scene 8 of an example use of an embodiment of an adapter 100 for a deep neural network (DNN) 110 according to an embodiment of the present invention. In the scene 8, a vehicle, such as a road vehicle 20, is illustrated traveling along a roadway 21. The vehicle 20 is employing a camera 30 being used in connection with a self-navigating control system 40.

During the vehicle's travel, the camera 30 captures images of the scene 8, which at a certain point along the roadway 21 becomes the scene-plus-fog 25. The camera 30 converts images into representations of the scene-plus-fog 105 and delivers the representations 105 to an imaging DNN 110. The representations 105 are also delivered to the DNN adapter 100, which works in connection with the imaging DNN 110 to cause the imaging DNN 110 to adapt rapidly to a changing condition, namely from a clear scene 8 to a scene-plug-fog 25.

In this example, fog is an example of corruption that may impact the camera's image of the scene, and many other types of conditions may introduce corruption effects that would otherwise negatively impact the performance of the imaging DNN 110 without the DNN adapter 100.

Further referring to FIG. 1A, the imaging DNN 110 and DNN adapter 100 communicate with each other in a manner that produces a highest-quality representation of the scene 8 consistently to the self-navigating control system 40, including when the vehicle 20 encounters the scene-plus-fog 25.

In this example, at t=0, the camera 30 has captured the scene 8 in advance of encountering the scene-plus-fog 25, and a representation 32a of the scene 8 is transmitted from the imaging DNN 110 to the self-navigated control system 40. During the vehicle's travel, the camera 30 captures the scene-plus-fog 25, and the DNN adapter 100 actively causes the imaging DNN 110 to adapt to the change of condition. At t=1, a representation 32b of the scene plus fog 25 may be presented to the self-navigating control system 40 from the imaging DNN 110. Because of the DNN adapter 100, the imaging DNN 110 quickly adapts, and, thereafter, at t=2, the imaging DNN 110 produces a representation (32c) of the scene plus minimal effects of fog to the self-navigating control system 40. In this manner, the self-navigating control system 40 can perform as well as possible with high quality presentations of representations of the scene plus whatever corruption effects may be captured by the camera 30.

It should be understood that typical machine learning training of elements associated with the DNN adapter 100 with respect to various corruption effects may be done in advance to support the DNN adapter, where the various corruption effects may be, for example, fog, rain, snow, bright sunlight.

FIG. 1B shows an overview of an embodiment of DARDA, in which a step-by-step walk-through of DARDA is provided, and shows an embodiment of DNN adapter processes 190 in accordance with aspects of the present invention. First, a data stream of non-independent and identically distributed (non-IID) data can shift due to some corruption that is also correlated in label space (distribution of labels are not uniform) (1, step 1). Corruption in the non-IID data is then detected and extracted (2, step 2), resulting in a latent representation (3, step 3), referenced herein as signature for brevity. Then, the corruption signature C_{cur} is assigned to the closest corruption centroid C*. Each centroid is learned during training and represents a known corruption type. Moreover, each centroid is associated with a “bootstrapped” sub-network of the main DNN that is specifically tailored to the specific corruption. The sub-network signature S* is then used to retrieve the actual sub-network structure and weight (4, step 4), which is then immediately plugged into the DNN (5, step 5). Next, the DNN is updated to match the type of ongoing corruption (not seen during the sub-network and corruption signature training phase) (6, step 6) by “moving” the current sub-network signature S_{cur} closer to the actual ongoing corruption C_{cur} (7, step 7).

Likewise, FIG. 1C depicts components and workflows of an embodiment of DARDA, including the DNN adapter 100. Current data 106, with corruption 107, (collectively referenced as 105) is fed into a corruption information extractor 115, which outputs a representation of corruption 117. The representation of corruption 117 is then inputted into a corruption encoder 120, which produces and outputs corruption signature C_{cur} 122 into a corruption latent space 135, which also contains information about the corruption signatures of known corruption types. Data from the latent space 135 is fed into the sub-network selector 125, which selects a sub-network and outputs coefficients for the DNN 110 to employ.

In one embodiment, Domain-Aware Rapid Dynamic Adaptation (DARDA) can seamlessly and effectively adapt in real-time state-of-the-art DNN to unseen corruptions. In some embodiments, DARDA can learn a latent space putting together the corruption process and the state of the DNN, which is done through a corruption extractor, a corruption encoder and a sub-network encoder, which together can make DARDA able to adapt the DNN seamlessly with unlabeled inputs.

Embodiments of DARDA were prototyped and performance evaluated against five state-of-the-art approaches, namely BN [10], TENT [17], CoTTA [19], NOTE [2], ROTTA [21] on the ResNet-56 DNN trained with the CIFAR-10 and CIFAR-100 datasets augmented with some known corruption types that are considered to be known prior to deployment. It was shown that DARDA improved the performance by 10.4% and 5.7% on CIFAR-10 and CIFAR-100, respectively, while performing 29% less forward computation and 77% less backward passes during the adaptation process and with only 16.57% of additional memory.

DARDA was implemented on Jetson-Nano and Raspberry Pi® 5, which are commonly used to exhibit efficiency of edge-deployed DNNs [4, 20]. Experiments showed that DARDA handled distribution shifts while being 1.74× more energy efficient than the best-performing state of the art Test Time Adaptation (TTA) algorithm. Also, for overall adaptation and inference task, DARDA takes 7.3× less time per sample while it occupies 2.64× less cache memory.

Some existing works [2, 16] on TTA have provided empirical evidence of performance improvement by only re-estimating the normalization statistics of Batch Normalization (BN) layers from test data. The absence of supervision is typically covered by two unsupervised forms of losses. Firstly, a line of work [3, 12, 18] minimizes entropy of predictions over a batch of data to prevent collapse of a trivial solution. Invariance regularization-based TTA algorithms perform some data augmentation (e.g., rotation [19], adversarial perturbation [11]) on test data during inference. An inconsistency of the prediction of a DNN on different augmented test data is leveraged as an unsupervised loss function to update the learnable parameters during inference.

The example DARDA framework uses cross-modal learning to acquire a shared representation space between the corruption space and the DNN space [13, 23].

Practical limitations of existing methods of TTA in edge vision application have been recognized by the inventors. These include the following:

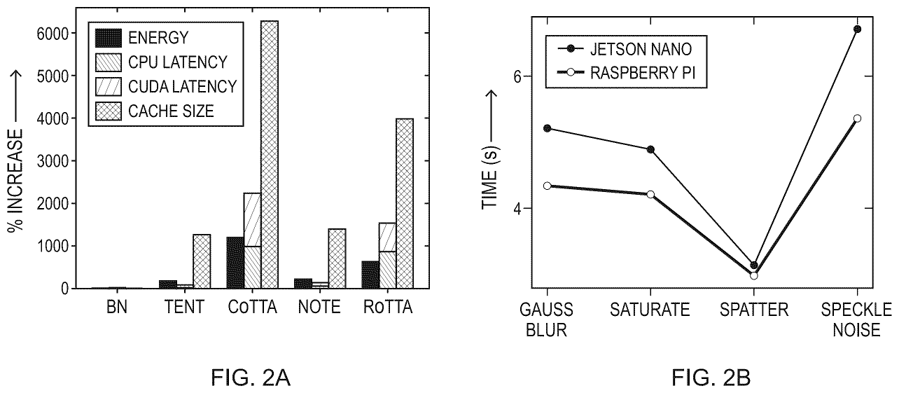

Excessive Resource Consumption. To improve performance, existing TTA approaches typically involve continuous adaptation even with uncorrupted input samples, thus imposing a heavy burden on edge resources. Ideally, adaptation should be only performed upon changes in the corruption process, thereby conserving constrained resources such as energy and processing power at the edge. Despite the potential benefits, current methods have yet to explore this direction. FIG. 2A shows a significant increase in resources between inference-only and existing TTA approaches in Jetson Nano™. Specifically, the energy consumption increases GPU latency up to 11.9×, along with a 6.8× increase in CPU latency and a 3.1× increase in GPU latency.

Higher Average Cache Usage. Mobile edge devices have limited memory size. As such, it is compelling to ensure TTA uses minimal memory footprint. Specifically, during inference, various blocks of a DNN are executed sequentially, and the cache memory usage at any given time is bounded by the data size of the activation map of the block being computed. However, as the TTA dynamically updates the DNN, local gradients of learnable parameters with respect to intermediate activation are stored, a quantity that scales with both the DNN size and the number of learnable parameters. From FIG. 2A, it is observed that the average cache usage increases by up to 21.7 compared to a DNN deployed for inference only.

Dependence on Sample Diversity. To be effective in real-world scenarios, the dynamic adaptation of a DNN needs to happen in a rapid fashion. However, FIG. FIG. 2B shows that existing state-of-the-art work takes significant time to restore the performance of the original DNN when the noise condition keeps changing. The reason behind such behavior lies in the inherent dependency on sample diversity [21]. In other words, if diverse samples are not observed with a new corruption process, the work cannot achieve its optimum performance gains.

To approach the problem, we define dₛ as the number of available learning domains, each characterizing a different imperfection and/or corruption type. We further define the related set of dₛ datasets where xᵢ^{d} and yᵢ^{d} indicates i^{th} data sample and label from domain d respectively, as

$${𝒟}^{d} = {\{ ( {x}_{i}^{d} , {y}_{i}^{d} ) \}}_{i = 1}^{{n}_{d}} , with 0 \leq d < {d}_{s} . \qquad ( 1 )$$

Each dataset [symbol] ^{d} is composed of n_{d}_{ₛ} independent and identically distributed (IID) samples characterized by some probability distribution P^{d}(X, Y) where X and Y are random variables of input and output respectively. It is assumed that a DNN has been trained on an uncorrupted dataset and dₛ sub-networks f(·; θ_{d}) are created so that (i) their architecture includes the batch normalization layer and the dense layers of the DNN; (ii) their weights θ_{d} are obtained by fine-tuning each sub-network to each specific domain. It is assumed that there is continuous and correlated (thus, non-IID) data flow to the DNN in real time, coming from du unknown domain datasets [symbol] ^{u}, with 0≤u<dᵤ. By unknown, it is meant that P^{u}(X, Y)≠P^{d}(X, Y), for all (0≤d<dₛ, 0≤u<dᵤ). A domain latent space [symbol] ⊂ [symbol] ^{o} is defined, where o is the dimension of the latent space. The goal is to (i) sense when the data flow has changed domain from the current domain d to the unknown domain u; (ii) infer domain t that is closest to u in the latent space; (ii) select the related fine-tuned sub-network f(·; θₜ) to quickly recover performance, and (iii) adapt f(·; θₜ) so as to find optimal f*(•; θ*) such that:

$${θ}_{t}^{*} = {arg min}_{{θ}_{t}} \frac{1}{{n}_{u}} {\sum }_{i = 1}^{{n}_{u}} ℒ \{ f ( {x}_{i}^{u} ; {θ}_{t} ) ; {y}_{i}^{u} \} \qquad ( 2 )$$

where nᵤ is a given number of samples in the unknown domain. Such samples are assumed to be available sequentially and the distribution of labels is different from the current domain's, i.e., P^{u}(X, Y)≠P^{d}(X, Y). Notice that ground truth labels yᵢ^{u} are usually not available in real-world settings and are only used for performance evaluation.

### Description of Domain-Aware Real-Time Dynamic Adaptation (DARDA) Framework

In one embodiment, components of DARDA are a corruption extractor, a corruption encoder and a model encoder, a new corruption-aware memory bank, new batch normalization scheme and a new real-time adaptation module.

### DARDA Corruption Extractor

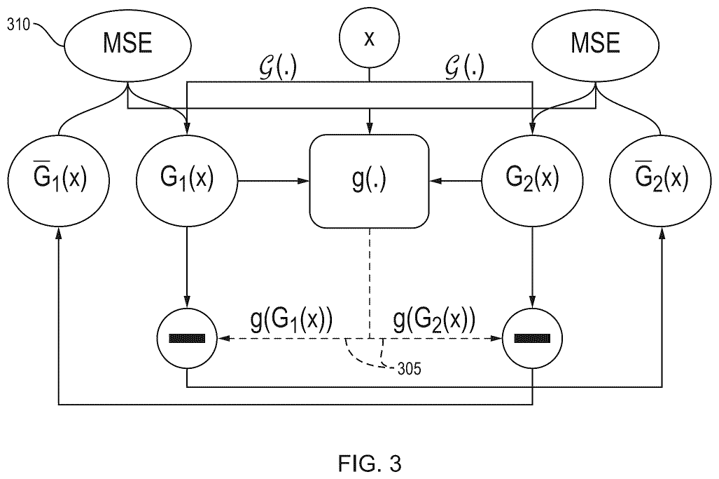

FIG. 3 shows an example of a corruption extraction approach. An intuition of the inventors was that features related to corruption and semantic features for inference are tightly intertwined. Since decoupling these features is difficult without corresponding clean samples, they designed a process to decouple corruption features without corresponding clean samples. Specifically, this involves learning the corruption features by mapping corrupted data to a different corrupted version of the same data [6, 8]. For a given corrupted data x, it is down sampled through two convolution kernels with static filters

G₁(·)=[[0,0.5],[0.5,0]] and G₂(·)=[[0.5,0],[0,0.5]]

to generate two downsampled versions of the corrupted data. From the first down sampled corrupted data G₁(x), it is attempted to create an exact copy of the other down sampled data G₂ (x) by subtracting some residual information learned by passing G₁(x) through the corruption extractor g(·). This predicted copy is denoted as \tilde{G}₂(x). Similarly, \tilde{G}₁(x) is computed from G₂ (x). The mapping functions are as follows:

$${\tilde{G}}_{2} ( x ) = {G}_{1} ( x ) - g ( {G}_{1} ( x ) ) \qquad ( 3 )$$

$${\tilde{G}}_{1} ( x ) = {G}_{2} ( x ) - g ( {G}_{2} ( x ) ) \qquad ( 4 )$$

In FIG. 3, the extracted residual is denoted by dotted lines 305. The parameters of g(·) can be optimized by minimizing the following loss function, which is the loss mean squared error (MSE) 310 indicated in FIG. 3.

$${ℒ}_{N} = {\sum }_{c = 1}^{{d}_{s}} {\sum }_{i = 1}^{{n}_{{d}_{s}}} \frac{1}{2} ( {‖ {\tilde{G}}_{2} ( {x}_{e , i} ) - {G}_{2} ( {x}_{c , i} ) ‖}_{2}^{2} + {‖ {\tilde{G}}_{1} ( {x}_{c , i} ) - {G}_{1} ( {x}_{e , i} ) ‖}_{2}^{2} ) \qquad ( 5 )$$

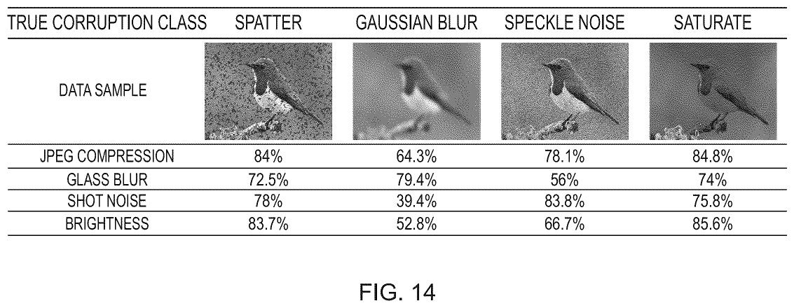

The intuition behind the approach is that the pixel values of the uncorrupted data in close proximity are usually highly correlated. Therefore, two downsampled versions of the data would be almost the same since they were generated by averaging values in close proximity. The corruption process breaks this correlation. Thus, the extractor g(·) learns to extract a representation of the corruption to generate uncorrupted data. This loss function is designed in Eq. (5) to create an opposite dynamics that enable extraction of information about the corruption process. It has been theoretically proven through Proposition 1 that, for additive noise the approach learns to extract information about the corruption. In FIG. 14 it is empirically verified that the Figure corruption extractor is useful for different kinds of corruption in general.

### DARDA Corruption Encoder

The corruption-related features are used to detect a corruption shift in real time. Specifically, a corruption encoder h(·) is used to encode corruption information of the input data from the known corruption types into a projection in the corruption latent space. While generating the latent space, it is ensured that samples from the same corruption distribution are grouped together in that latent space and samples from different corruption distribution are located distant from each other. For the N samples {Cⁱ,Dⁱ}ᵢ₌₁^{N} in a training data batch, C is defined as the set of each corruption projection Cⁱ in the latent space. Dⁱ is defined as the corruption label for projection Cⁱ, and as D the corresponding set. The following supervised contrastive loss function is defined for a batch of training data:

$${ℒ}_{D} ( C , D ) {\sum }_{i = 1}^{2 \cdot N} {ℒ}_{D}^{i} ( C , D ) \qquad ( 6 )$$

where [symbol] _{D}ⁱ(C,D) is defined as

$${ℒ}_{D}^{i} ( 𝒞 , D ) = \frac{- 1}{2 \cdot {n}_{{d}_{s}} - 1} {\sum }_{j = 1}^{2 \cdot N} {1}_{( i \neq j ) \& ( {D}^{i} \neq {D}^{j} )} \times log \frac{exp ( {C}^{i} \cdot {C}^{j} / τ )}{{\sum }_{k = 1}^{2 \cdot N} {1}_{( k \neq i )} exp ( {C}^{i} \cdot {C}^{k} / τ )} \qquad ( 7 )$$

where N represents the total number of samples in the batch and τ is a scaling parameter. While training the corruption encoder, a soft augmentation (random rotations and flips) is generated from each data sample to have more samples from each noise classes. This way, the training batch size becomes 2·N. For each sample i in the training batch, its contrastive loss is calculated using Eq. (7). Here, the numerator enforces cosine similarity between similar corruption types and the denominator penalizes high similarity between projections which are from different corruption class. Thus, similar corruption projections are positioned closer and dissimilar ones are positioned far apart. The corruption extractor g(·) and corruption encoder h(·) are jointly trained by minimizing the loss function:

$$ℒ = {ℒ}_{D} + {λ}_{e} \cdot {ℒ}_{N} \qquad ( 8 )$$

where λₑ is a constant which does not have a significant effect on the performance, yet makes the convergence of g(·) and h(·) faster. The training process is described in Algorithm 2.

### DARDA Sub-Network Encoder

To guide the adaptation of the sub-network, it is needed to obtain a “fingerprint” of the current sub-network, whose state space is by definition, continuous and infinite. This issue is addressed by creating a set of unique fingerprints F¹ . . . . F^{d}^{ₛ} of each sub-network by feeding a fixed Gaussian noise into the DNN and considering its output response vector as the fingerprint of the sub-network. The intuition is that since a DNN works as a non-linear function approximator, it will produce a different output for the same input with different parameters. A signature S^{d} of each sub-network is generated from each fingerprint F^{d} as S^{d}= [symbol] (F^{d};ψ) where S:F→ [symbol] ^{o} which is a shallow neural network parameterized by y that maps the fingerprint to the corruption latent space. The S encoder is trained so as to minimize the following loss function, which maximizes the cosine similarity between the latent space projections:

$${ℒ}_{CM} = {\sum }_{i = 1}^{{d}_{s}} {\sum }_{j = 1}^{{d}_{s}} {1}_{i = j} \{ exp ( - {S}^{i} \cdot {C}^{j} ) \} \qquad ( 9 )$$

Here, 1(·) is the indicator function. A regularization term is used in addition to [symbol] _{CM} to distribute encoder S's projection in regions from where sub-network's projections would produce well-performing sub networks. The measured cosine similarity between a sub-network signature Sᵢ and a corruption signature Cⱼ is converted into probability distribution πᵢⱼ using:

$${π}_{ij} = σ ( \frac{{S}^{i} \cdot {C}^{j}}{{\sum }_{k = 1}^{{d}_{s}} {S}^{k} \cdot {C}^{k}} ) , i , j ∈ [ 0 , {d}_{s} ] \qquad ( 10 )$$

where σ is the softmax function. If αᵢⱼ indicates accuracy of sub-network i in corruption domain j probability distribution αᵢⱼ can be generated such as

$${α}_{ij} = σ ( \frac{log 1 / ( 1 - {a}_{ij} )}{{\sum }_{k = 1}^{{d}_{s}} log 1 / ( 1 - {a}_{ik} )} ) , i , j ∈ [ 0 , {d}_{s} ] \qquad ( 11 )$$

The sub-network encoder can be calibrated to generate projections that have affinity with other corruption domains where it can perform well by minimizing the KL divergence between πᵢⱼ and αᵢⱼ. Hence, the regularization term [symbol] ᵣ and the overall loss [symbol] ₘ that the sub-network encoder is trained on becomes:

$${ℒ}_{r} = {\sum }_{i = 1}^{{d}_{s}} {\sum }_{j = 1}^{{d}_{s}} log \frac{{π}_{ij}}{{α}_{ij}} \qquad ( 12 )$$

$${ℒ}_{m} = {ℒ}_{CM} + {λ}_{r} {ℒ}_{r} \qquad ( 13 )$$

where 0<λᵣ<1 is a regularization parameter.

### Corruption-Aware Memory Bank

In practical scenarios, the distribution of labels differs from the actual label distribution. Importantly, while during training, the DNN is given input data with IID labels, in real-world scenarios sequential data is highly correlated while other classes are very scarce at a particular time. Adaptation to this unreliable label distribution leads to substantial performance loss in traditional approaches. To address this problem, it is desirable to have a stable snapshot of the ongoing corruption at inference time. Thus, a memory bank [symbol] is created an maintained with [symbol] slots to store samples. The memory bank is constructed in a label-balanced manner. Recalling that Y is the set of labels, for each class y∈Y,

$$\frac{𝒩}{\vert Y \vert}$$

number of incoming test samples are stored. As there are no labeled data, the labels are inferred from the prediction ŷ of the model. However, sampling based on prediction of continuously adapted model leads to error accumulation [21]. To solve error accumulation, existing methods [19, 21] resort to simultaneous inference with multiple DNNs by feeding different augmented views of test samples to them. However, this requires additional storage requirements for multiple simultaneous inference. Although sensing the corruption and bootstrapping with proper sub-network signature leads to reliable memory bank construction, its projection is stored to have the samples that are only representative of the ongoing corruption. For each incoming test samples, its class label is predicted, and stored in the memory bank if there is room for that particular class and if it is highly representative of the ongoing corruption. The process of memory bank construction is described in Algorithm 1.

### Corruption-Aware Batch Normalization

Due to sudden corruption, the normalization statistics (μ̅,σ̅²) estimated on uncorrupted training data become unreliable. Although using a specific sub-network with normalization statistics (μₛ,oₛ²) would be feasible, the samples stored in the memory bank can be used to further refine our estimation of the ongoing statistics (μₜ,oₜ²). To this end, BN is used [7]. Let A^{t}∈ [symbol] ^{B×Ch}^{^{l}}^{×N}^{^{l}} be a batch of activation tensors of the l^{th} convolutional layer, where B corresponds to the batch size, Ch^{l} denotes the number of channels in l^{th} layer and Nₗ is the dimension of activations in each channel. A BN layer first calculates

$${μ}_{Ch} = \frac{1}{\vert B \vert \vert {N}^{i} \vert} {\sum }_{b ϵ B , n ϵ {N}^{l}} ( {A}^{l} ) and {σ}_{Ch} = \frac{1}{\vert B \vert} {\sum }_{b ϵ B} {( {A}^{l} - {μ}_{Ch} )}^{2}$$

and subtracts μ_{Ch} from all input activations in the channel. Subsequently, BN divides the centered activation by the standard deviation σ_{Ch}. Normalization is applied:

$$BN ( {A}_{b , Ch , {N}^{l}}^{i} ) ← γ \times \frac{{A}_{b , Ch , {N}^{l}}^{l} - {μ}_{Ch}}{\sqrt{{σ}_{Ch}^{2} + ϵ}} + β ∀ b , Ch , {N}^{l} \qquad ( 14 )$$

Here, γ and β are the affine scaling and shifting parameters followed by normalization, while (ϵ>0) is a small constant added for numerical stability. The normalized and affine transformed outputs are passed to the next (l+1)^{th} layer, while the normalized output is kept to the lth layer. BN also keeps track of the estimate of running mean and variance to use during the inference phase as a global estimate of normalization statistics, and γ and β are optimized with the other DNN parameters through back propagation.

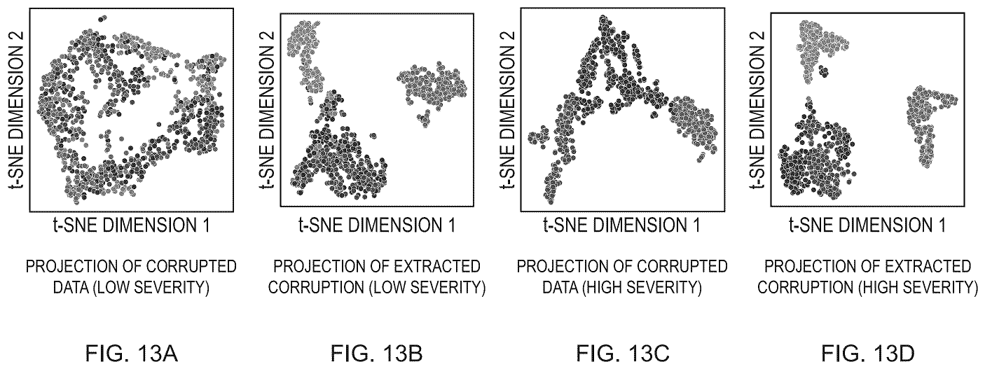

At each change in corruption, the projection from the corruption encoder matches with the closest corruption centroid in the latent space. At the same time, samples affected by the new corruption are being stored in the memory bank. As we constrict the memory bank to have certain amount of samples from a particular class, due to the design of non IID real world data stream, initially there will be samples from previous corruption distribution also on the memory bank. FIGS. 13A-13D show that the projections for even the unknown corruption get clustered nearby in the latent space. When the samples of the memory bank become representative of the current corruption, they should have low variance among their cosine similarity with current closest corruption centroid C_{cur}. Therefore, when the change in corruption is sensed, and the variance of cosine similarity from the centroid becomes lower than a threshold φₜₕᵣₑₛₕ, current DNN normalization statistics are updated as:

$${μ}_{s} = ( 1 - m ) \cdot {μ}_{s} + m \cdot {\hat{μ}}^{t} \qquad ( 15 )$$

$${σ}_{s}^{2} = ( 1 - m ) \cdot {σ}_{s}^{2} + m \cdot {\hat{σ}}_{t}^{2}$$

where m is the momentum and (\hat{μ}ₜ,\hat{σ}²) are the current normalization statistics of different layers of the DNN, which we obtain by making one forward pass using the samples in the memory bank.

### Corruption-Aware Real-Time DNN Adaptation

Adapting the parameters of the current DNN in an un-supervised manner usually needs careful selection of hyper parameters. To avoid this issue, only the sub-network is adapted. As explained earlier, one forward pass is made with the samples in the memory bank and the fixed Gaussian noise to calculate the normalization statistics of the current ongoing corruption and current sub-network fingerprint. The mean of the corruption embedding

$$\overline{C} = \frac{1}{𝒩} {\sum }_{i = 1}^{𝒩} {C}^{i}$$

of the samples in the memory bank and the sub-network projection S is also calculated. Specifically, the tuneable parameters of the sub-network (shift β and scale γ parameters of the BN layer and final fully connected layers) are updated using gradient descent to minimize the following unsupervised loss:

$${ℒ}_{u} = exp ( - S \cdot \overline{C} ) \qquad ( 16 )$$

Notice that no access to labeled data is assumed, and pseudo-labels (i.e., DNN prediction) are not used as labels. Conversely, the loss is minimized between corruption embedding and model state in the latent space which is not disrupted by the corruption, as it is designed to estimate the corruption process itself.

### Experimental Results

The tool described in [9] was used to synthetically generate realistic corruptions for CIFAR-10 and CIFAR-100 datasets. Both CIFAR-10 and CIFAR-100 have 50,000 training images and 10,000 testing images. In line with prior work, the following 15 different corruptions of different categories were used which are “Noise” (Gaussian, shot, impulse), “Blur” (defocus, glass, motion, zoom), “Weather” (snow, frost, fog, bright) and “Digital” (contrast, elastic, pixelate, JPEG) to train the corruption encoder. For fair comparison, the performance was evaluated on 4 corruptions (Gaussian blur, saturate, spatter, speckle noise) which were unseen during training phase. In line with [2,17,19,22], the corruptions were considered in their highest severity.

Comparison with State-of-the-Art Benchmarks

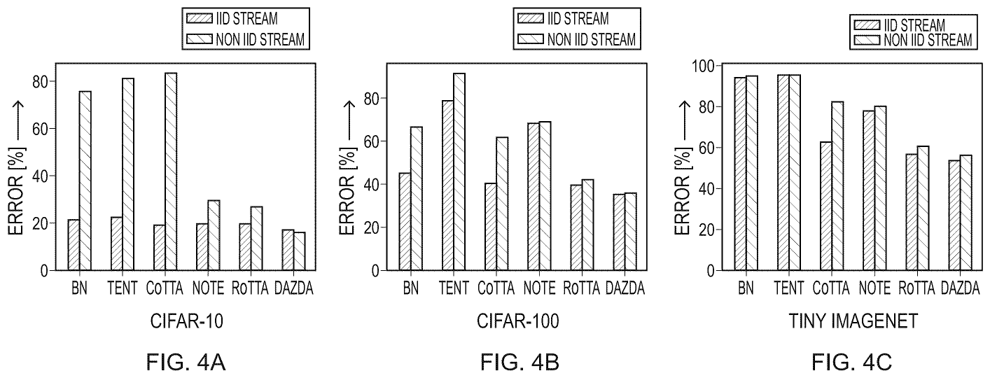

FIG. 4A and FIG. 4A show the performance of Domain-Aware Real-Time Dynamic Adaptation (DARDA) as compared to other approaches. Results are shown with ideal independent and identically distributed (IID) assumption and a more realistic non-IID assumption (i.e., samples are correlated).

As can be observed, DARDA performed consistently better in both datasets and across both setups, with DARDA improving the performance by 10.4% on CIFAR-10 test corruptions and 5.7% on CIFAR-100 compared to the 2nd best performing baseline RoTTA. Among the other considered baselines, TENT, COTTA and BN achieved poor performance for non-IID samples. Since DARDA starts from a bootstrapped sub-network in changed corruption domain and update only with samples from the memory bank and corruption latent space, DARDA performs consistently well in both cases. Since NOTE is equipped to handle correlation among online data batches, there is no significant performance drop for non-IID assumption. However, NOTE resets the DNN after evaluation on each corruption type which is unrealistic as it does not have the capability to know when current corruption domain is changing. Thus, due to error accumulation for continuous adaptation, the performance is fairly poor. DARDA does not accumulate errors from the previous corruption domain, as in every new corruption domain it starts from a new DNN state.

### Sensitivity to Correlated Samples

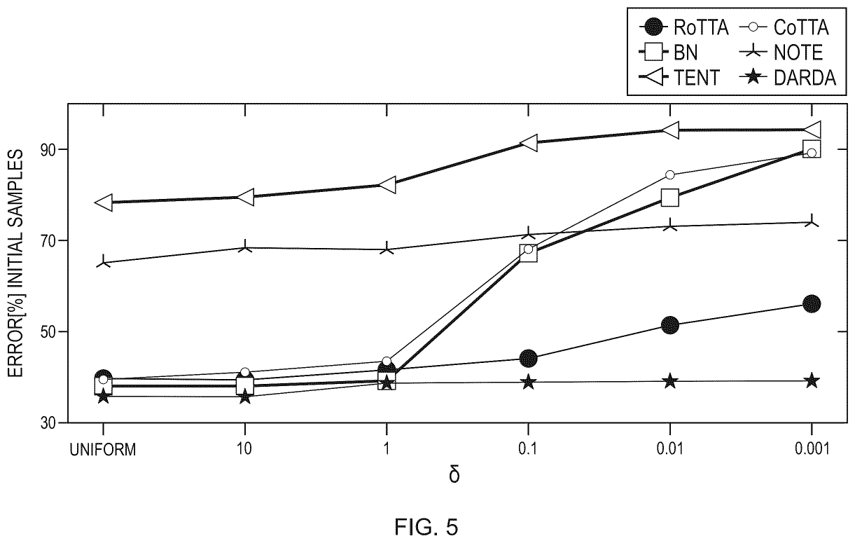

The performance of DARDA does not depend on the label space to bootstrap from an appropriate sub-network. To prove this point, the average performance was plotted in the first five batches of incoming data by varying the value of the correlation parameter & for the CIFAR-100 dataset using sequences similar to those used for FIG. 4B. From FIG. 5 it emerges that the correlation does not have a sensible effect on DARDA. Furthermore, as the value of & decreases, the performance of BN and CoTTA drastically decreases, and for the best method ROTTA, performance starts to plummet when encountering severe correlation. Indeed, with high correlation among samples, there is not enough sample diversity to have a stable update of the DNN. However, DARDA can reliably sense corruption drift even with a single sample and bootstrap with the most similar sub-network stored in the buffer. Thus, even for extremely correlated samples, we have a well-performing sub-network from the early instances of data batches after incurring in corruption. This indicates the efficacy and reliability of DARDA in critical mobile edge computing scenarios.

### Effect of Batch Size and Dirichlet Parameter

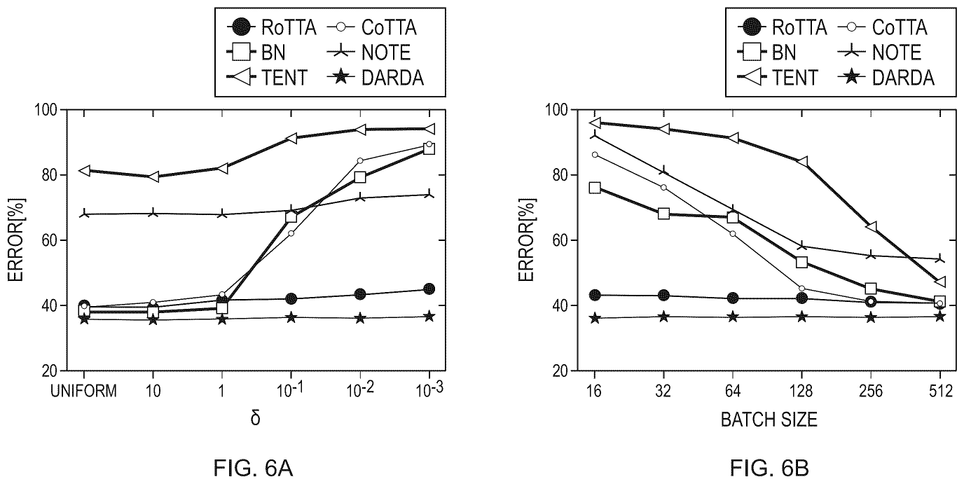

From FIGS. 6A and 6B is can be observed that the batch size and Dirichlet parameter do not have a significant effect on performance of DARDA. This is because the corruption signature can be extracted even with a single sample. Moreover, by updating the normalization statistics of the BN layer using a memory bank that enforces diversity among samples, we ensure that samples are representative of the ongoing corruption. Among other approaches, a higher value of batch size leads to high performance gain for TENT, BN and CoTTA. Especially for COTTA, with batch size greater than 128, the performance reaches up to RoTTA. Also, the overall effect of Dirichlet parameter & is less prominent than the initial batches.

### Evaluation of Catastrophic Forgetting

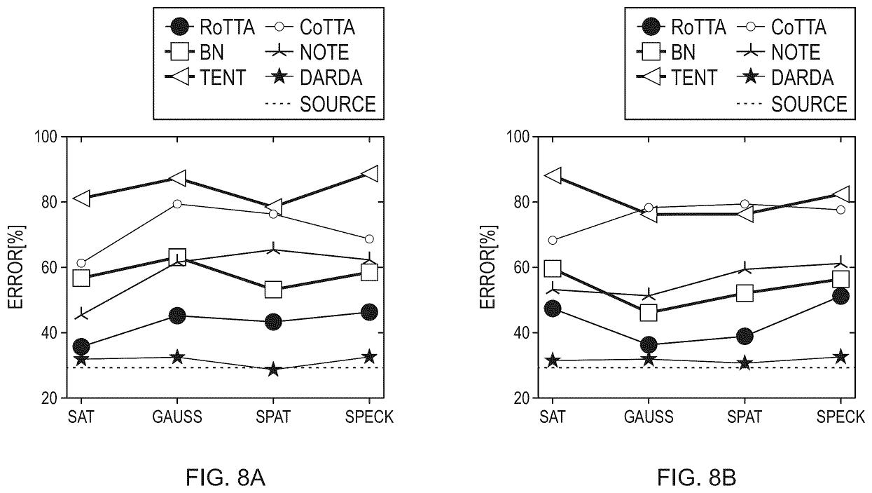

The adaptation of DNN should not result in performance degradation on uncorrupted inputs, since in most real-life scenarios uncorrupted data is most common. However, during Test Time Adaptation (TTA), the DNN might get specialized in certain corruptions and fail to deliver performance. FIGS. 8A and 8B show the performance showing 5 uncorrupted data batches from CIFAR-10 after two sequences, which are (on the left subfigure, FIG. 8A) saturate→Gaussian blur→spatter→speckle and (on the right subfigure) Gaussian blur→saturate→spatter→speckle. FIGS. 8A and 8B conclude that conversely from DARDA, state-of-the-art approaches incur in catastrophic forgetting. The best-performing baseline ROTTA has its accuracy degraded by up to 22% when uncorrupted data is fed after speckle noise. The classification error is particularly high when uncorrupted data is fed after a more severe corruption type (e.g, Gaussian blur) than the milder one (e.g, spatter).

### On-Device Dynamic Adaptation Efficiency

In this section, the on-device performance of DARDA was evaluated in diverse edge platforms. Commonly available Raspberry-Pi-5 and Nvidia Jetson-Nano were selected, since they are representative of resource-constrained devices widely applied for mobile vision applications.

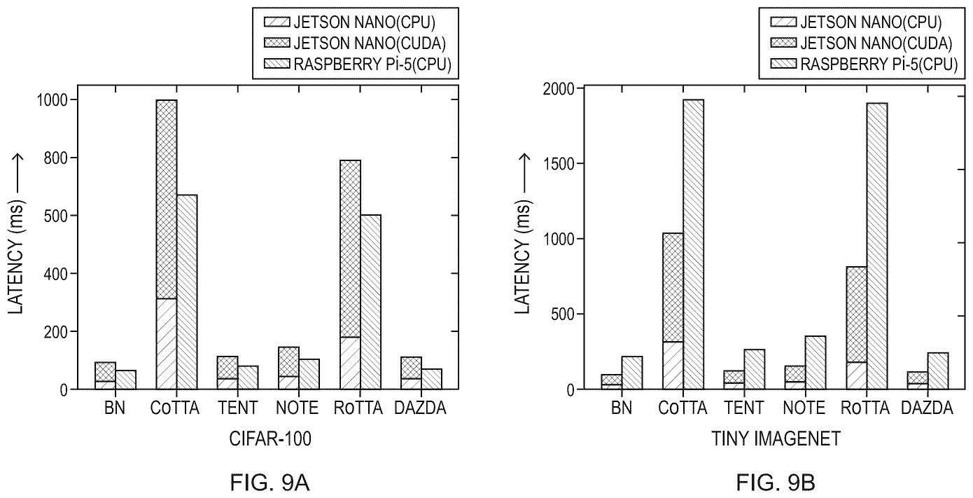

DARDA adapts using one backward pass to update the sub-network only when a corruption is perceived by the corruption extractor. The corruption extractor and corruption encoder are also active for each data sample. Table 1 reports the average number of multiply and accumulate (MAC) operations for the forward pass of each method. For the backward pass, the average number of samples for different corruptions with which the backward pass was called is reported. To calculate DARDA forward pass MAC, all the operations involved in the corruption extractor, corruption encoder and sub-network encoder are summed with the operation performed by different subnetworks. To support continuous adaptation without error accumulation, CoTTA and RoTTA continuously perform two forward passes with the original data sample and another augmented sample respectively. Thus, their number of operations is two times more than BN, TENT and CoTTA. Although BN, TENT and NOTE have less forward computation than DARDA, the unrealistic assumption of independent and identically distributed (IID) data stream and episodic adaptation-notice that the DNN state is continuously reset after adaptation-which makes them not applicable in real time mobile edge applications. From FIGS. 9A and 9B it is also evident that DARDA incurs lower CPU and GPU latency compared to closest performing benchmarks.

TABLE 1
Comparison of Computation and Average Cache
Usage of DARDA and other approaches while performing
continuous adaptation on CIFAR-100.

| | | Average no. samples | Average no. Samples |
|---|---|---|---|
| Method | Cache(Mb) | Forward MACS | Backward Pass |
| BN | 67 | 1.28 × 10¹² | 0 |
| TENT | 914 | 1.28 × 10¹² | 10,000 |
| CoTTA | 4271 | 2.56 × 10¹² | 10,000 |
| NOTE | 1003 | 1.28 × 10¹² | 10,000 |
| RoTTA | 2735 | 2.56 × 10¹² | 10,000 |
| DARDA | 312 | 1.82 × 10¹² | 2294 |

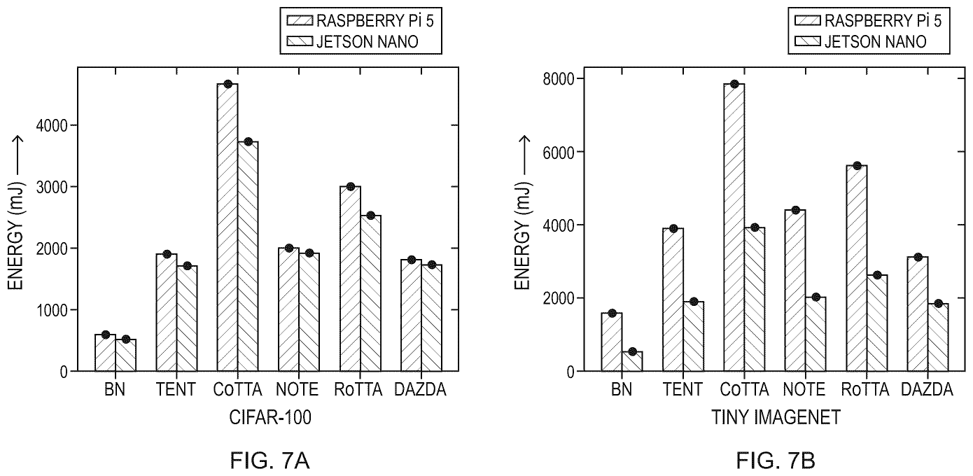

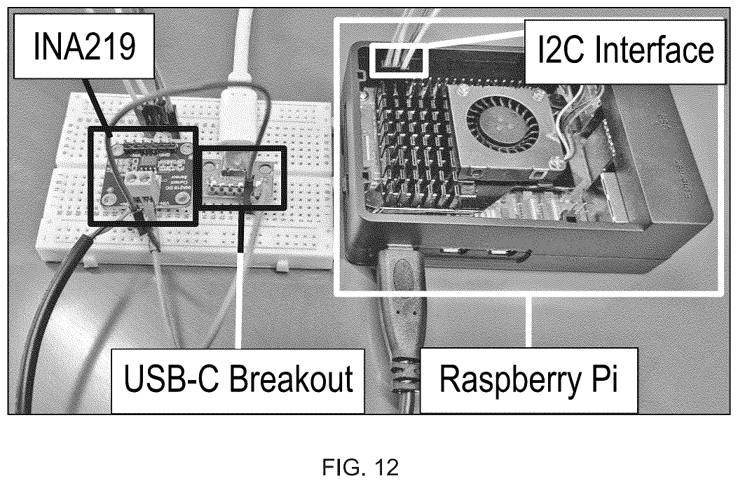

From Table 1, it can be observed that there is an excessive amount of cache usage during adaptation, except for BN, which can slow down or even block some other tasks a user is interested in using the same device. For example, the closest performing baseline ROTTA in continual adaptation settings needs 8.78× cache than DARDA. Although BN needs less cache usage than DARDA to operate as it does not need to store gradient for backward pass, it performs poorly, as shown in the section “Comparison with State of the Art Benchmarks,” above. From FIGS. 7A and 7B, it is observed that DARDA uses 2.9× less energy than the closest performing benchmark in terms of performance. To calculate the energy consumption value, the setup in FIG. 12 is used.

### Impact of Submodules of DARDA

To investigate the contribution of different components toward performance gain, different parts of DARDA were replaced using different alternative options. The related performance is reported in Table 2. The following were considered: (i) DARDA without Corruption Extractor, where corrupted data is directly projected into latent space; (ii) DARDA without context-aware BN & Adaptation, directly using the DNN constructed from current sub-network signature for prediction; (iii) DARDA with context-aware BN & without fine tuning, we update the normalization values of the BN layers using samples from the memory bank but do not update the tunable parameters; (iv) DARDA with context-aware BN and Entropy Minimization, where we update the tunable parameters by minimizing entropy of predictions.

TABLE 2
Effect of Individual Components of DARDA.

| | Error [%] | Error [%] |
|---|---|---|
| Variants of DARDA | (CIFAR-10) | (CIFAR-100) |
| w/o Corruption Extractor | 36.7 | 56.9 |
| w/o Context Aware BN | 22.7 | 41.5 |
| & Adaptation | | |
| with Context Aware BN | 23.8 | 42.9 |
| w/o Adaptation | | |
| with Context Aware BN | 23.9 | 42.7 |
| & Entropy Minimization | | |
| Ours | 16.3 | 36.4 |

From Table 2 it can be observed that the corruption extractor is crucial for the performance as erroneous corruption projection would select the wrong sub-network. Creating corruption projections using only corrupted data leads to performance drop of 20.4% and 16.6% on CIFAR-10 and CIFAR-100 unseen corruption respectively. Context-aware BN with adaptation is also important as the accuracy reduces by 6.4% and 5.1% respectively for test corruptions on CIFAR-10 and CIFAR-100, respectively. It is an interesting observation that for CIFAR-10, updating the tunable parameters by minimizing entropy of predictions degrades the performance by 0.1% rather that improving. However, our loss [symbol] ₙ in Eq. (16) results up to 1.2% performance gain which proves that a learned cross-modal latent space can guide DNN adaptation.

### CONCLUSION

According to aspects of the present invention, some embodiments of Domain-Aware Real-Time Dynamic Neural Network Adaptation (DARDA) can proactively learn latent representations of a limited number of corruption types, each one associated with a sub-network tailored to classify correctly inputs affected by that corruption. DARDA adapts the DNN to previously unseen corruptions in an unsupervised fashion by (i) estimating the latent representation of the ongoing corruption; (ii) selecting the sub-network whose associated corruption is the closest in the latent space to the ongoing corruption; and (iii) adapting the DNN state, so that its representation matches the ongoing corruption. This way, DARDA is more resource-efficient and can swiftly adapt to new distributions without requiring a large variety of input data. Through experiments with two popular mobile edge devices-Raspberry Pi® and NVIDIA Jetson Nano™—it has been shown that DARDA reduces energy consumption and average cache memory footprint respectively by 1.74× and 2.64× with respect to the state of the art, while increasing the performance by 10.4%, 5.7% and 4.4% on CIFAR-10, CIFAR-100 and TinyImagenet.

### Supplemental Materials

### Different Domain Generalization Setup

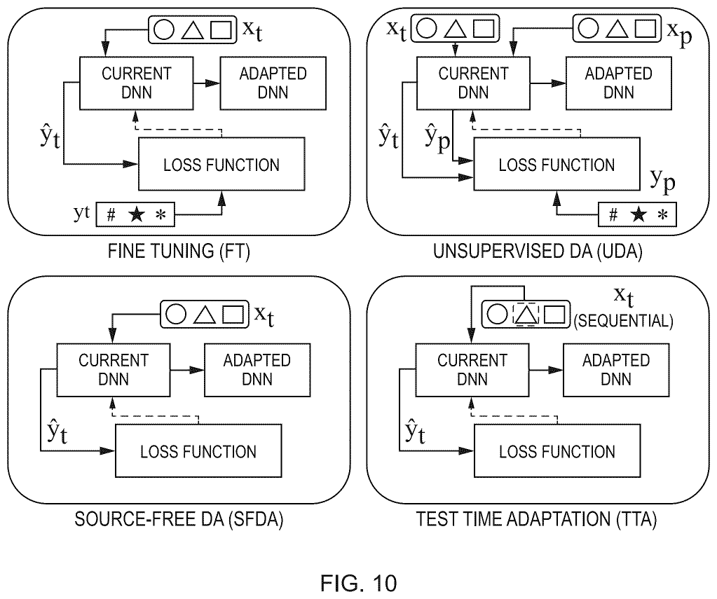

The problem of adapting a Deep Neural Network (DNN) to tackle real life data corruption at the edge can be formulated by different kind of Domain Generalization (DG) settings based on the nature of data stream and learning paradigm. FIG. 10 summarizes the four main DG approaches in literature, namely Fine Tuning (FT), Unsupervised Domain Adaptation (UDA), Source-Free Domain Adaptation (SFDA) and Test Time Adaptation (TTA).

Fine Tuning (FT) adapts a DNN by making it match labeled test data [24, 28]. FT approaches includes Few-Shots Learning (FSL), among others [30]. The downside of FT is that it requires labeled test data and is performed offline, thus they are hardly applicable in a mobile edge computing context. Moreover, it does not take into account samples from the previous domain, so it incurs in catastrophic forgetting [25].

Unsupervised Domain Adaptation (UDA). This approach addresses the issues of FT considering samples from the previous domain and thereby eliminating the need of labels from the new domain [33]. However, as FT, UDA assumes that we can simultaneously access (unlabeled) samples from the current domain and from the prior domain, which is not always the case. In opposition, the present invention can, in some embodiments, achieve real-time adaptation of a DNN in dynamic and uncertain scenarios.

Source-Free Domain Adaptation (SFDA). Conversely from UDA, in SFDA the DNN adaptation is performed using unlabeled data from the target domain only [26, 27]. While SFDA approaches take into account numerous losses for several epochs during optimization, the key downside is that it can hardly be applied in real-time learning settings.

Test Time Adaptation (TTA). A practical approach to address distributional shifts in real-time settings is TTA, which utilizes only unlabeled test data (online) to adapt the DNN. While existing TTA approaches improve performance, they are sensitive to the diversity of samples in incoming distributions. For example, even in cases of minor changes in brightness, approaches adapting the normalization layer based on entropy minimization such as [29, 31] can experience a significant decrease in accuracy, dropping to less than 19% of accuracy on CIFAR-10. Moreover, existing methods are not aware of domain changes, so they continuously update the DNN even in the presence of no domain change. Notice that decoupling the corruption from the features relevant for classification is extremely challenging. Such continuous adaptation leads to the risk of catastrophic forgetting. While state-of-the-art work uses stochastic restoration of parameters to the initial domain to tackle the issue, it needs 78.37% more storage for ResNet56 architecture than the described approach herein.

### Distribution and Label Shift

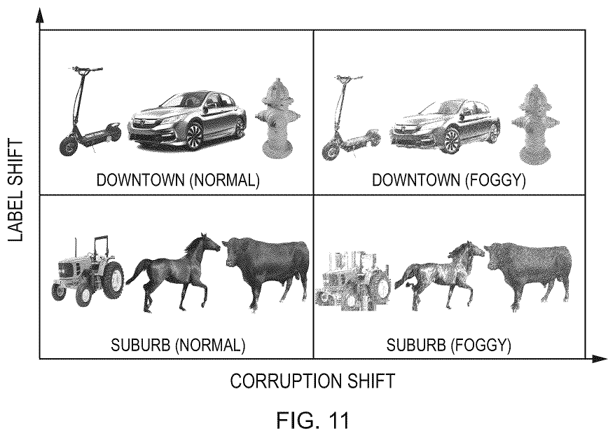

Different corruptions lead mainly to a distribution shift in the input data, which is also widely known as a covariate shift. Distribution shift happens when the distribution of input data changes while the distribution of true labels remain unchanged. In a real-life adaptation of DNNs at inference time, there is usually a batch of samples to work with that have both distribution and label shift (due to correlation in labels in certain scenarios) at the same time. FIG. 11 illustrates this scenario with an example. This setting is challenging for most existing TTA algorithms, but is more practical.

### Hyperparameters and Implementation Details

Domain-Aware Real-Time Dynamic Adaptation (DARDA) was implemented with the PyTorch framework. For generating non independent and identically distributed (IID) real time data flow, Dirichlet distribution (with parameter δ) was adopted to create a non-IID data flow. Furthermore, to simulate a domain change due to corruption, samples were fed from different test corruption types sequentially one after another following Dirichlet distribution with control parameter δ, when all samples from the current test corruption are exhausted. With lower values of the Dirichlet parameter δ, there is less diversity among online data batches, thus less correlation. The noise extractor is designed in a lightweight manner with three convolution layer with Leaky-ReLU non-linearity stacked sequentially. For the noise encoder, a sequential model was used consisting of two convolution units each consisting of a single convolution layer with ReLU non-linearity and a MaxPooling layer. The sequential model is followed by two dense layers. The sub-network encoder consists of two dense layers with ReLU non-linearity. For the reported results, we choose the output dimension of the sub-network encoder and the corruption encoder were chosen, i.e. the dimension of latent space to be 128 and the batch size is kept at 64, while the size of the memory bank is kept the same as batch size.

For CIFAR-100 corrupted dataset, one cannot insert samples from all classes in the memory bank. The parameter value δ=0.1 is considered across all test scenarios unless otherwise specified. However, it was found empirically that presence of representative samples from the majority of the classes is sufficient. Adam optimizer was used with learning rate 1×10³ to perform the adaptation. To generate the sub-network signature, a ResNet-56 backbone was first trained on the uncorrupted training dataset (CIFAR-10 and CIFAR-100) and the sub-networks were fine-tuned for 20 epochs using data from 15 train corruption domain to create the 15 subnetworks and their related signatures. For the hyper parameters, a fixed set of values was assumed throughout the experiments, which are λᵣ=0.2, λₑ=10, φₜₕᵣₑₛₕ=0.005 and momentum value m=0.5. As we make one step upgrade of the current Batch Normalization (BN) layer statistics by making sure that the samples of the memory banks are reliable, we chose a rather aggressive momentum value to weigh the normalization of current test samples highly.

### Power Measurement Setup

As both Raspberry Pi® and Jetson Nano™ do not have a system integrated in them to measure power at a certain instance, the setup of FIG. 12 was used to calculate the energy consumption of different adaptation methods. The ina219 IC can provide accurate power consumption for a device at a certain time. Some samples of power measurement are initially taken to estimate the idle power usage of the device. Then for the whole adaptation period of each algorithm, samples of power drawn by the device are taken every 10 ms. Multiplying with the sampling time and averaging over batches of data a very good estimate of the energy consumption was obtained of different adaptation algorithms.

### Performance of Corruption Extractor

As discussed previously, in a corrupted data sample the corruption related features are intertwined with label information which impedes extraction of contextual information from data.

To verify whether the corruption extractor is effective in extracting corruption information from data, the corruption extractor and encoder were trained using data available from 15 different corruptions and evaluate how it performs for unknown corruption and different severity. FIG. 13 shows the t-distributed stochastic neighbor embedding (t-SNE) of the projections in the latent space of data from different corruption domains and different levels of severity.

```
Algorithm 1: Memory Bank Construction
Input: A test sample x¹; and associated corruption
embedding Cⁱ; current corruption projection C^{curr}
Define: memory bank [symbol] ; total capacity [symbol] ;
class distribution n[y], where y ∈ Y; total occupancy [symbol]  <
Calculate ŷ = arg max_{y} f [symbol]  (y | x [symbol]  )
$if n [ \hat{y} ] < ⌈ \frac{𝒩}{\vert Y \vert} ⌉ and 𝒪c \text{<\textbar} 𝒩 \vert then$
      Add (x^{t}, C^{t}) to [symbol]
    else
      Calculate cosine similarity fₐᵢₘ of corruption
      projection among instances in {n|ŷ] ∪ x^{t}} and C^{curr}
      Find instance ( [symbol]  , [symbol] ) in n [ŷ] with the lowest similarity
      arg min_{x∈|ŷ|} f [symbol]   (x, C^{curr}) to current signature
    end if
    if f [symbol]  (\tilde{x}) > f [symbol]  (x^{t}) then
      Discard (x^{t}, C^{t})
    else
      Remove instance (\tilde{x}, \tilde{C}) from [symbol]
      Add (x^{t}, C^{t}) to [symbol]
    end if [symbol]
indicates data missing or illegible when filed
```

In FIGS. 13A and 13C, the corruption projections are made directly using the input data. Here, it can be observed that directly encoding the corrupted data does not produce clusters with tight boundaries. Interestingly, FIG. 13B and FIG. 13D point out that projecting the corruption signature extracted from the corrupted data does produce significantly better clusters. Moreover, although samples from the “spatter” and “saturate” have an overlapping boundary in latent space, from FIG. 14 we can see that although they are visually dissimilar, a sub-network that performs well for the “spatter” also works well for “saturate”. This means that DARDA is effective not only in categorizing and mapping corruptions, but also in designing appropriate subnetworks. Moreover, FIG. 13D shows that the corruption extractor produces an even better cluster with higher severity data from unknown corruption domain even if it was trained on a lower corruption severity. This proves the intuition that the corruption extractor extracts corruption information rather than simply over-fitting to the joint distribution of data and corruption.

### Memory Bank Construction Process

The memory bank construction process is described in detail in Algorithm 1.

### More Details of Corruption Encoder

The processes involved both in the training and inference phase of the Corruption Encoder is illustrated through Algorithm 2.

Algorithm 2: Corruption Encoder

```
Input: dataset [symbol]    ^{d}; epochs E; batch size N; constant τ
and λₑ [symbol]   ; embed dimension o; pair downsampler [symbol]    (,) ;
transformation set [symbol]    ; structure of g(,) and h(,)
Output: projection vector into corruption latent space
{training}
for epoch = 1 to E do
  sample {xᵢ, Dⁱ}ₜ₌₁^{N}
  sample two augmentations [symbol]    ^{a}, [symbol]    ^{b} ~ [symbol]
  generate two down sampled data
  G₁(xᵢ), G₂(xᵢ) = [symbol]    (xᵢ)
  calculate G₁(xᵢ), G₂(xᵢ) using Eq. (3)
  calculate [symbol]    ₙ using Eq. (5) [symbol]
  generate xᵢ^{a}, xᵢ^{b} = [symbol]    ^{a}(xᵢ), [symbol]    ^{b}(xᵢ)
  generate G₁(xᵢ^{a}), G₂(xᵢ^{a}) = [symbol]    (xᵢ^{a}) and
  G₁(xᵢ^{b}), G₂(xᵢ^{b}) = [symbol]    (xᵢ^{b})
  extract xᵢ's corruption xᵣₑₛ_{ᵢ}, by concatenating
  xᵣₑₛ_{ᵢ} = g((G₁(xᵢ)) ∥ g(G₂(xᵢ))
  calculate the latent space projections Cⁱ by
  Cⁱ = h(xᵣₑₛ_{ᵢ})
  calculate [symbol]    _{D} using Eq. (6)
  calculate overall loss using Eq. (8)
  update g(,) and h(,) to minimize [symbol]
end for {test}
for x in Dⁿ do
  generate G₁(x), G₂(x) = [symbol]    (x)
  calculate and concatenate comuption features
  xᵣₑₛ = g(G₁(x))∥g(G₂(x))
  calculate projection into latent space by
  C = h(xᵣₑₛ)
end for [symbol]
indicates data missing or illegible when filed
```

### Theoretical Analysis of the Corruption Encoder

Insights are offered into the information learned by the corruption encoding process through a theoretical analysis of the corruption encoder for additive noise.

Proposition 1. Let two noisy observations from original sample x be y₁=G₁(x) and y₂=G₂ (x). Assuming zero mean and independent additive noise; y₁=x+e₁ and y₁=x+e₁; where noise is denoted by eᵢ. If eᵢ can be approximated by g(·): eᵢ=g_{φ}(yᵢ) by minimizing MSE loss between clean observation xᵢ and noisy observation yᵢ, minimizing the loss between two noisy observation approximate the same thing.

$$Proof .$$

$$\begin{matrix}g ( {y}_{1} , x ; ϕ ) = {arg min}_{ϕ} 𝔼 [ {‖ {y}_{1} - {g}_{ϕ} ( {y}_{1} ) - x ‖}_{2}^{2} ] \\ = {arg min}_{ϕ} 𝔼 [ {‖ {g}_{ϕ} ( {y}_{1} ) ‖}_{2}^{2} - 2 {y}_{1}^{T} {g}_{ϕ} ( {y}_{1} ) + 2 {x}^{T} {g}_{ϕ} ( {y}_{1} ) ]\end{matrix} \qquad [ 2 ]$$

$$\begin{matrix}g ( {y}_{1} , {y}_{2} ; ϕ ) & = & {arg min}_{ϕ} 𝔼 [ {‖ {y}_{1} - {g}_{ϕ} ( {y}_{1} ) - {y}_{2} ‖}_{2}^{2} ] & [ 3 ] \\ & = & {arg min}_{ϕ} 𝔼 [ {‖ {y}_{1} - {g}_{ϕ} ( {y}_{1} ) - x - {e}_{2} ‖}_{2}^{2} ] & \\ & = & {arg min}_{ϕ} 𝔼 [ {‖ {g}_{ϕ} ( {y}_{1} ) ‖}_{2}^{2} - 2 {y}_{1}^{T} {g}_{ϕ} ( {y}_{1} ) + 2 {x}^{T} {g}_{ϕ} ( {y}_{1} ) + & [ 4 ] \\ & & 2 {e}_{2}^{T} {g}_{ϕ} ( {y}_{1} ) ] & \\ & = & {arg min}_{ϕ} 𝔼 [ {‖ {g}_{ϕ} ( {y}_{1} ) ‖}_{2}^{2} - 2 {y}_{1}^{T} {g}_{ϕ} ( {y}_{1} ) + 2 {x}^{T} {g}_{ϕ} ( {y}_{1} ) ] & [ 5 ] \\ & = & g ( {y}_{1} , x ; ϕ ) & \end{matrix}$$

Assuming zero mean E(eᵢ)=0 and independent noise the second to last equality is satisfied.

While example embodiments have been particularly shown and described, it will be understood by those skilled in the art that various changes in form and details may be made therein without departing from the scope of the embodiments encompassed by the appended claims.

### REFERENCES

[1] Amani Al-Shawabka, Francesco Restuccia, Salvatore D'Oro, Tong Jian, Bruno Costa Rendon, Nasim Soltani, Jennifer Dy, Kaushik Chowdhury, Stratis Ioannidis, and Tommaso Melodia. Exposing the Fingerprint: Dissecting the Impact of the Wireless Channel on Radio Fingerprinting. Proc. of IEEE Conference on Computer Communications (INFO-COM), 2020.
[2] Taesik Gong, Jongheon Jeong, Taewon Kim, Yewon Kim, Jinwoo Shin, and Sung-Ju Lee. Note: Robust continual test-time adaptation against temporal correlation. Advances in Neural Information Processing Systems, 35:27253-27266, 2022. 2, 6
[3] Sachin Goyal, Mingjie Sun, Aditi Raghunathan, and J Zico Kolter. Test time adaptation via conjugate pseudo-labels. Advances in Neural Information Processing Systems, 35:6204-6218, 2022. 2
[4] Rui Han, Qinglong Zhang, Chi Harold Liu, Guoren Wang, Jian Tang, and Lydia Y Chen. Legodnn: block-grained scaling of deep neural networks for mobile vision. In Proceedings of the 27th Annual International Conference on Mobile Computing and Networking, pages 406-419, 2021. 2
[5] Dan Hendrycks and Thomas Dietterich. Benchmarking neural network robustness to common corruptions and perturbations. arXiv preprint arXiv: 1903.12261, 2019. 1
[6] Tao Huang, Songjiang Li, Xu Jia, Huchuan Lu, and Jianzhuang Liu. Neighbor2neighbor: Self-supervised denoising from single noisy images. In Proceedings of the IEEE/CVF conference on computer vision and pattern recognition, pages 14781-14790, 2021. 3
[7] Sergey Ioffe and Christian Szegedy. Batch normalization: Accelerating deep network training by reducing internal covariate shift. In International conference on machine learning, pages 448-456. pmlr, 2015. 5
[8] Youssef Mansour and Reinhard Heckel. Zero-shot noise2noise: Efficient image denoising without any data. In Proceedings of the IEEE/CVF Conference on Computer Vi-sion and Pattern Recognition, pages 14018-14027, 2023. 3
[9] Claudio Michaelis, Benjamin Mitzkus, Robert Geirhos, Evgenia Rusak, Oliver Bringmann, Alexander S Ecker, Matthias Bethge, and Wieland Brendel. Benchmarking ro-bustness in object detection: Autonomous driving when winter is coming. arXiv preprint arXiv: 1907.07484, 2019. 6
[10] Zachary Nado, Shreyas Padhy, D Sculley, Alexander D'Amour, Balaji Lakshminarayanan, and Jasper Snoek. Evaluating prediction-time batch normalization for robustness under covariate shift. ICML 2020 Workshop on Uncertainty and Robustness in Deep Learning, 2020. 2
[11] A Tuan Nguyen, Thanh Nguyen-Tang, Ser-Nam Lim, and Philip HS Torr. Tipi: Test time adaptation with transformation invariance. In Proceedings of the IEEE/CVF Conference on Computer Vision and Pattern Recognition, pages 24162-24171, 2023. 2
[12] Shuaicheng Niu, Jiaxiang Wu, Yifan Zhang, Yaofo Chen, Shijian Zheng, Peilin Zhao, and Mingkui Tan. Efficient test-time model adaptation without forgetting. In Interna-tional conference on machine learning, pages 16888-16905. PMLR, 2022. 2
[13] Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervi-sion. In International conference on machine learning, pages 8748-8763. PMLR, 2021. 2
[14] Christos Sakaridis, Dengxin Dai, and Luc Van Gool. Acdc: The adverse conditions dataset with correspondences for se-mantic driving scene understanding. In Proceedings of the IEEE/CVF International Conference on Computer Vision, pages 10765-10775, 2021. 1
[15] Moamar Sayed-Mouchaweh and Edwin Lughofer. Learning in Non-Stationary Environments: Methods and Applications. Springer Science & Business Media, 2012. 1
[16] Steffen Schneider, Evgenia Rusak, Luisa Eck, Oliver Bring-mann, Wieland Brendel, and Matthias Bethge. Improving robustness against common corruptions by covariate shift adaptation. Advances in neural information processing sys-tems, 33:11539-11551, 2020. 2
[17] Dequan Wang, Evan Shelhamer, Shaoteng Liu, Bruno Ol-shausen, and Trevor Darrell. Tent: Fully test-time adaptation by entropy minimization. arXiv preprint arXiv: 2006.10726, 2020. 1, 2, 6
[18] Dequan Wang, Evan Shelhamer, Shaoteng Liu, Bruno Ol-shausen, and Trevor Darrell. Tent: Fully test-time adaptation by entropy minimization. In International Conference on Learning Representations, 2021. 2
[19] Qin Wang, Olga Fink, Luc Van Gool, and Dengxin Dai. Continual test-time domain adaptation. In Proceedings of the IEEE/CVF Conference on Computer Vision and Pattern Recognition, pages 7201-7211, 2022. 1, 2, 5, 6
[20] Hao Wen, Yuanchun Li, Zunshuai Zhang, Shiqi Jiang, Xiaozhou Ye, Ye Ouyang, Yaqin Zhang, and Yunxin Liu. Adaptivenet: Post-deployment neural architecture adaptation for diverse edge environments. In Proceedings of the 29th Annual International Conference on Mobile Computing and Networking, pages 1-17, 2023. 2
[21] Longhui Yuan, Binhui Xie, and Shuang Li. Robust test-time adaptation in dynamic scenarios. In Proceedings of the IEEE/CVF Conference on Computer Vision and Pattern Recognition, pages 15922-15932, 2023. 2, 3, 5
[22] Daqing Zhang, Dan Wu, Kai Niu, Xuanzhi Wang, Fusang Zhang, Jian Yao, Dajie Jiang, and Fei Qin. Practical Issues and Challenges in CSI-based Integrated Sensing and Com-munication. arXiv preprint arXiv: 2204.03535, 2022. 6
[23] Tong Zhu, Leida Li, Jufeng Yang, Sicheng Zhao, Hantao Liu, and Jiansheng Qian. Multimodal sentiment analysis with image-text interaction network. IEEE Transactions on Multimedia, 2022. 2
[24] Yunhe Gao, Xingjian Shi, Yi Zhu, Hao Wang, Zhiqiang Tang, Xiong Zhou, Mu Li, and Dimitris N Metaxas. Visual Prompt Tuning for Test-Time Domain Adaptation. arXivpreprint arXiv: 2210.04831, 2022. 1
[25] Tyler L Hayes, Kushal Kafle, Robik Shrestha, Manoj Acharya, and Christopher Kanan. Remind Your Neural Net-work to Prevent Catastrophic Forgetting. In Proceedings of European Conference on Computer Vision (ECCV), pages 466-483. Springer, 2020. 1
[26] Vinod K Kurmi, Venkatesh K Subramanian, and Vinay P Namboodiri. Domain impression: A source data free domain adaptation method. In Proceedings of the IEEE/CVF winter conference on applications of computer vision, pages 615-625, 2021. 1
[27] Rui Li, Qianfen Jiao, Wenming Cao, Hau-San Wong, and Si Wu. Model adaptation: Unsupervised domain adaptation without source data. In Proceedings of the IEEE/CVF con-ference on computer vision and pattern recognition, pages 9641-9650, 2020. 1
[28] Zhiqiu Lin, Samuel Yu, Zhiyi Kuang, Deepak Pathak, and Deva Ramanan. Multimodality Helps Unimodality: Cross-Modal Few-Shot Learning with Multimodal Models. In Pro-ceedings of the IEEE/CVF Conference on Computer Vision and Pattern Recognition (CVPR), pages 19325-19337, 2023. 1
[29] Shuaicheng Niu, Jiaxiang Wu, Yifan Zhang, Yaofo Chen, Shijian Zheng, Peilin Zhao, and Mingkui Tan. Efficient test time model adaptation without forgetting. In International conference on machine learning, pages 16888-16905. PMLR, 2022. 1
[30] Feng Tian, Yue Yu, Xu Yuan, Bin Lyu, and Guan Gui. Predicted Decoupling for Coexistence Between WiFi and LTE in Unlicensed Band. IEEE Transactions on Vehicular Technology, 69 (4): 4130-4141, 2020. 1
[31] Dequan Wang, Evan Shelhamer, Shaoteng Liu, Bruno Olshausen, and Trevor Darrell. Tent: Fully test-time adaptation by entropy minimization. arXiv preprint arXiv: 2006.10726, 2020. 1
[32] Qin Wang, Olga Fink, Luc Van Gool, and Dengxin Dai. Continual test-time domain adaptation. In Proceedings of the IEEE/CVF Conference on Computer Vision and Pattern Recognition, pages 7201-7211, 2022. 1
[33] Garrett Wilson and Diane J Cook. A survey of unsupervised deep domain adaptation. ACM Transactions on Intelligent Systems and Technology (TIST), 11 (5): 1-46, 2020. 1

What is claimed is:

1. An adapter for a deep neural network having a plurality of subnetworks, the adapter comprising:
a corruption information extractor to extract a representation of corruption from current data;
a corruption encoder to encode the representation of corruption affecting current data into a corruption signature;
a sub-network selector configured to select a sub-network from among the plurality of subnetworks of the deep neural network, each of the subnetworks being associated with a degree or type of corruption and having corresponding sub-network corruption signatures from sub-network encoder, the selection being based on a distance of the current corruption signature from the sub-network corruption signatures; and
an update module configured to update the deep neural network based on an error output by the deep neural network using the sub-network selected.

2. The adapter of claim 1, wherein the corruption information extractor is configured to extract the representation of corruption from the current data based on a comparison of two downsampled versions of the current data.

3. The adapter of claim 1, wherein the corruption encoder is configured to project the representation of corruption of the current data into a latent space to encode the current corruption signature.

4. The adapter of claim 1, wherein the sub-network encoder is further configured to extract a representation of the sub-network state from each of the plurality of subnetworks.

5. The adapter of claim 1, wherein the sub-network encoder is further configured to encode the representation of the current updated sub-network state into the corresponding sub-network signature.

6. The adapter of claim 5, wherein the selected sub-network is updated based on the error output calculated from the distance between the current corruption signature and the sub-network signature.

7. The adapter of claim 1, wherein the deep neural network is employed in an autonomous or semi-autonomous machine to cause the machine to exhibit performance characteristics, and wherein the adapter is coupled to a sensor arranged to obtain the current data from an environment at the machine, the environment known to have corruption effects associated therewith that cause the sensor to obtain the current data with corruption.

8. The adapter of claim 7, wherein the machine is a vehicle and the deep neural network is associated with processing images of a scene at the vehicle, the adapter configured to update the deep neural network at transitions of corruption effects within images of the scene.

9. The adapter of claim 8, wherein the corruption effects include at least one of: fog, snow, rain and sunlight.

10. The adapter of claim 8, wherein the vehicle is an automobile.

11. A method for adapting a deep neural network having a plurality of subnetworks, the method comprising:
extracting a representation of corruption from current data;
encoding the representation of corruption affecting current data into a corruption signature;
selecting a sub-network from among the plurality of sub-networks of the deep neural network, each of the sub-networks being associated with a degree or type of corruption and having corresponding sub-network corruption signatures, the selecting being based on a distance of the current corruption signature from the sub-network corruption signatures;
and updating the deep neural network based on an error output by the deep neural network using the subnetwork selected.

12. The method of claim 11, wherein the extracting of the representation of corruption is based on a comparison of two downsampled versions of the current data.

13. The method of claim 11 wherein the encoding includes projecting the representation of corruption of the current data into a latent space to encode the current corruption signature.

14. The method of claim 11, further comprising extract a representation of the sub-network state from each of the plurality of subnetworks.

15. The method of claim 11, further comprising encoding the representation of the current updated sub-network state into the corresponding sub-network signature.

16. The method of claim 15, wherein updating the deep neural network is based on the error output calculated from the distance between the current corruption signature and the sub-network signature.

17. The method of claim 11, further comprising obtaining the current data via a sensor from an environment at an autonomous or semi-autonomous machine, the environment known to have corruption effects associated therewith that cause the sensor to obtain the current data with corruption.

18. The method of claim 17, wherein the machine is a vehicle and further comprising processing images of a scene observable from the vehicle, and updating the deep neural network at transitions of corruption effects in images of the scene.

19. The method of claim 18, wherein the corruption effects include at least one of: fog, snow, rain and sunlight.

20. The method of claim 18, wherein the vehicle is an automobile.
